(19) United States
(12) Patent Application Publication
(10) Pub. No.: US 2013/0133442 A1
(43) Pub. Date: May 30, 2013

(54) SAMPLE COLLECTION APPARATUS AND METHODS FOR MAKING AND USING THE SAME

(71) Applicants: Matthew Edward Knapp, Marblehead, MA (US); Michael Edgar Patterson, Arnesbury, MA (US)

(72) Inventors: Matthew Edward Knapp, Marblehead, MA (US); Michael Edgar Patterson, Arnesbury, MA (US)

(21) Appl. No.: 13/306,686

(22) Filed: Nov. 29, 2011

(51) Int. Cl. G01N 1/12; B23P 11/00

(52) U.S. Cl. 73/864.63; 29/428

(57) ABSTRACT

A sample collection apparatus for use with a collection trap is provided. The apparatus includes a handle and a sample collection assembly coupled to the handle. The sample collection assembly includes a cradle and a cover. The cradle is coupled to the handle at a first end portion of the cradle. The cradle includes an opening defined therethrough by vertical side walls extending between an upper surface of the cradle and a lower surface of the cradle. The cover includes a projection member and a block. The cover is coupled to a second end portion of the cradle. The projection member includes the block configured to be at least partially inserted through the cradle opening.

### BACKGROUND OF THE INVENTION

The embodiments described herein relate generally to a sample collection apparatus and, more particularly, to a collection apparatus for collecting a sample of trace particles.

At least some known contraband detection devices detect contraband based on trace particles associated with a person and/or an object. As used herein, the term “contraband” refers to illegal substances, explosives, narcotics, weapons, special nuclear materials, dirty bombs, nuclear threat materials, a threat object, and/or any other material that a person is not allowed to possess in a restricted area, such as an airport or a border crossing. To collect a sample of trace particles, the trace particles can be captured on or in a trap, such as a substrate, a wipe, a sheet of material, and/or any other suitable object that collects trace particles. However, when a user directly holds the trap during collection of trace particles, the user can become contaminated by the person and/or object and/or the trap can become contaminated by the user. As such, a known trace particle collection apparatus can be used to facilitate avoiding such contamination.

One known apparatus includes a handle and an arm pivotally mounted to the handle through a slot in the handle. A head is connected to and extends from the handle. The head includes a ring having a bore defined therethrough. The ring retains the substrate within the bore. The arm includes a boss on a first end thereof. The first end of the arm and the boss are movable relative to the head between an open configuration and a closed configuration. In the open configuration, the boss is spaced from the head to permit insertion and removal of a substrate, and in the closed configuration, an edge portion of the substrate is trapped between the ring and the boss. Further, in the closed configuration, the boss projects through the bore causing a working portion of the substrate to project outwardly.

### BRIEF DESCRIPTION OF THE INVENTION

In one aspect, a sample collection apparatus for use with a collection trap is provided. The apparatus includes a handle and a sample collection assembly coupled to the handle. The sample collection assembly includes a cradle and a cover. The cradle is coupled to the handle at a first end portion of the cradle. The cradle includes an opening defined therethrough by vertical side walls extending between an upper surface of the cradle and a lower surface of the cradle. The cover includes a projection member and a block. The cover is coupled to a second end portion of the cradle. The projection member includes the block configured to be at least partially inserted through the cradle opening.

In another aspect, a method for using a sample collection apparatus to collect a sample of a substance is provided. The method includes providing the sample collection apparatus including a sample collection assembly coupled to a handle. The sample collection assembly includes a cradle and a cover, wherein the cover is in an open position with respect to the cradle. A collection trap is positioned within the cradle such that the collection trap covers an opening defined through the cradle. The method further includes rotating the cover with respect to the cradle from the open position to a closed position, and forcing the collection trap at least partially through the opening using a block extending from the cover.

In yet another aspect, a method for making a sample collection apparatus is provided. The method includes providing a cradle including an inner surface and an opposing outer surface. The cradle includes an opening defined therethrough by vertical side walls extending between the inner surface of the cradle and the outer surface of the cradle. The method further includes providing a cover including a projection member and a block configured to be at least partially inserted through the cradle opening, and rotatably coupling the cover to a first end portion of the cradle. The cover and the cradle form a sample collection assembly. The sample collection assembly is coupled to an end of a handle.

### BRIEF DESCRIPTION OF THE DRAWINGS

FIGS. 1-16 show exemplary embodiments of the apparatus and methods described herein.

FIG. 1 is a top view of an exemplary sample collection apparatus with a cover in an open position.

FIG. 2 is a side view of the sample collection apparatus shown in FIG. 1.

FIG. 3 is a bottom view of the sample collection apparatus shown in FIG. 1.

FIG. 4 is a top perspective view of a sample collection assembly of the sample collection apparatus shown in FIG. 1.

FIG. 5 is a side perspective view of the sample collection assembly shown in FIG. 4.

FIG. 6 is an end perspective view of the sample collection assembly shown in FIG. 4.

FIG. 7 is an end view of the sample collection apparatus with the cover in a closed position.

FIG. 8 is a bottom view of the sample collection apparatus shown in FIG. 7.

FIG. 9 is a top perspective view of an exemplary alternative sample collection apparatus.

FIG. 10 is a top view of an exemplary trap that may be used with the sample collection apparatus shown in FIGS. 1-8 and/or the sample collection apparatus shown in FIG. 9.

FIG. 11 is a top view of the sample collection apparatus shown in FIGS. 1-8 including the trap shown in FIG. 10 with the cover in the open position.

FIG. 12 is a top perspective view of the sample collection apparatus and the trap shown in FIG. 11.

FIG. 13 is a bottom view of the sample collection apparatus shown in FIGS. 1-8 including the trap shown in FIG. 10 with the cover in the closed position.

FIG. 14 is a side view of the sample collection apparatus and the trap shown in FIG. 13.

FIG. 15 is a flowchart of an exemplary method of making the sample collection apparatus shown in FIGS. 1-8.

FIG. 16 is a flowchart of an exemplary method of using the sample collection apparatus shown in FIGS. 1-14.

### DETAILED DESCRIPTION OF THE INVENTION

The embodiments described herein provide an apparatus for collecting a sample of a substance, such as particles, particulates, vapors, and/or other traces of an unknown substance. More specifically, the embodiments described herein provide a wand-shaped sample collection apparatus for use in collecting particulates to be analyzed in an ion mobility spectrometer and/or an ion trap mobility spectrometer. The sample collection apparatus includes a sample collection assembly, an optional removable extension section, and a removable handle. The apparatus described herein properly positions a collection trap, such as a substrate or a swab, in the sample collection assembly to ensure a “sweet spot” of the collection trap, such as a collection portion, is exposed to a person and/or an object. Such positioning of the collection trap facilitates simplifying usability, while reducing cross-contamination when handling the collection trap. Further, the removable extension section enables sample collection in deeper cavities.

The sample collection assembly provides unique retention of the collection trap therein. More specifically, the collection trap is captured by bypassing surfaces using material surface tension of an abutting pliant block of the sample collection assembly. Such capture technique facilitates reducing distortion of the collection trap within the sample collection assembly. In a particular embodiment, the block is a removable, soft, durometer polymer pad that cushions the collection trap to mimic contact of a human finger and that can easily be removed for cleaning or replacement.

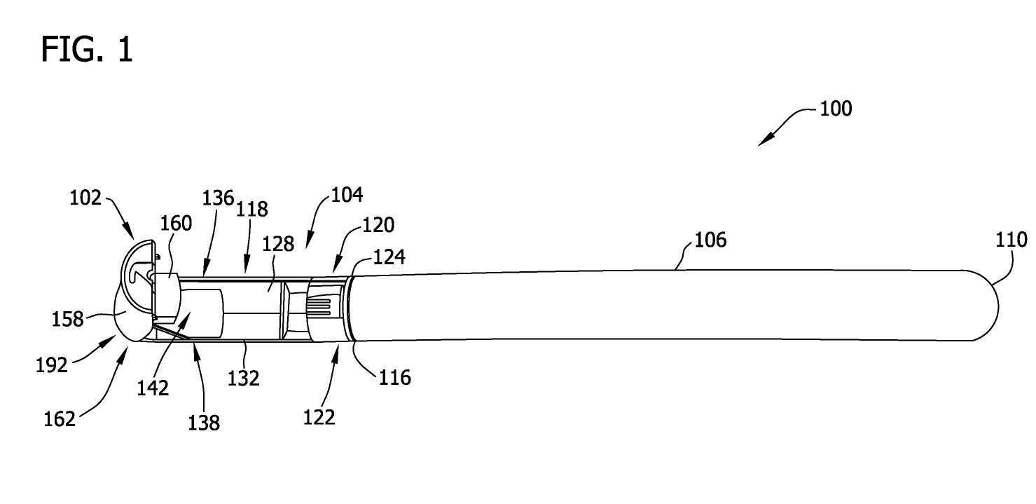

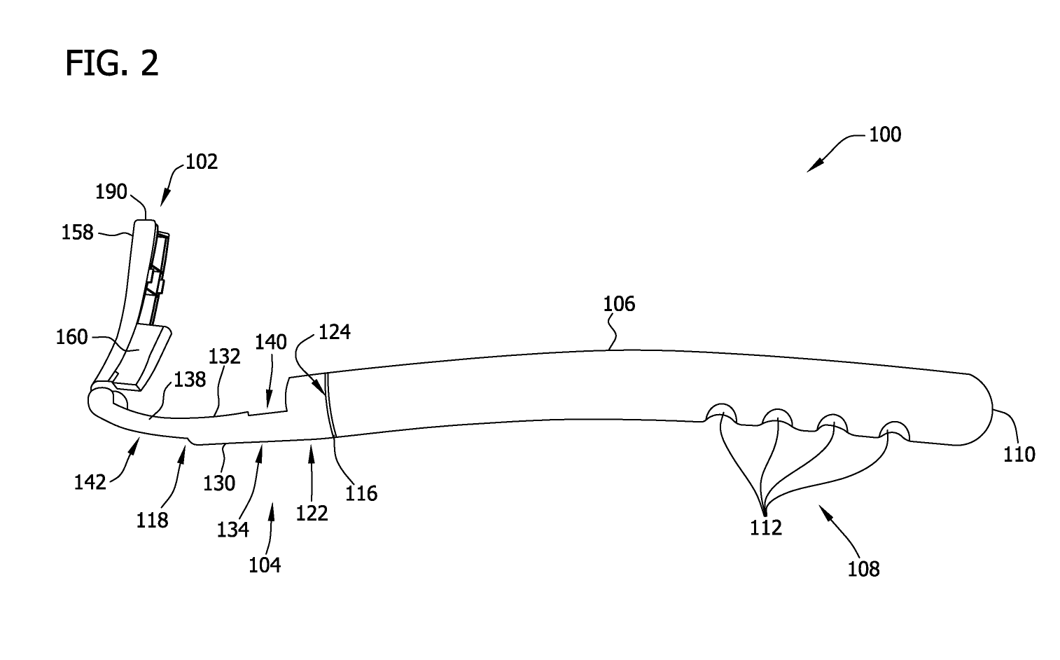

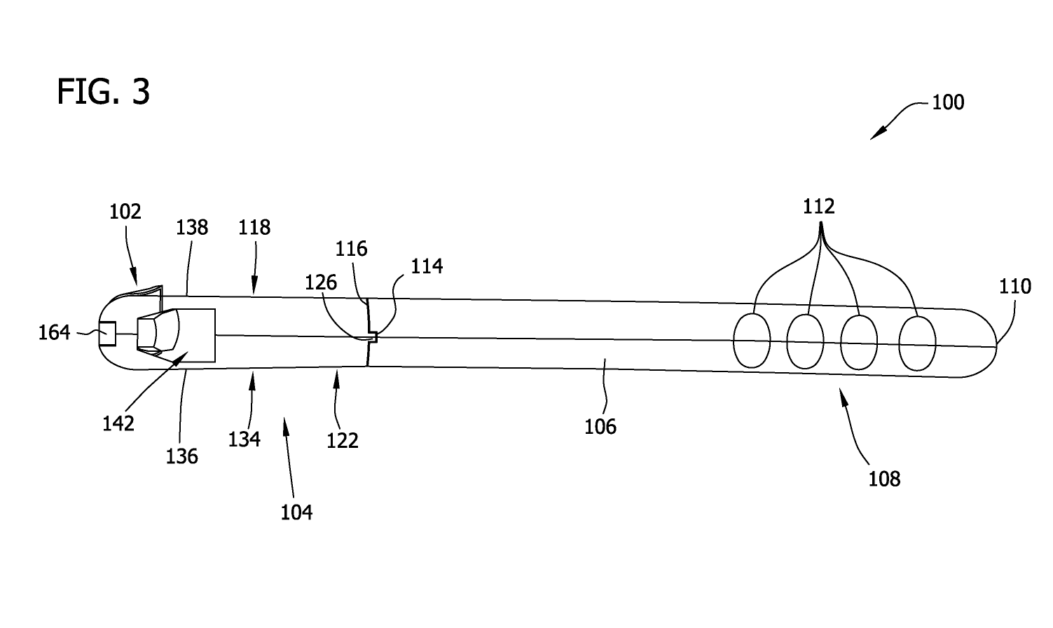

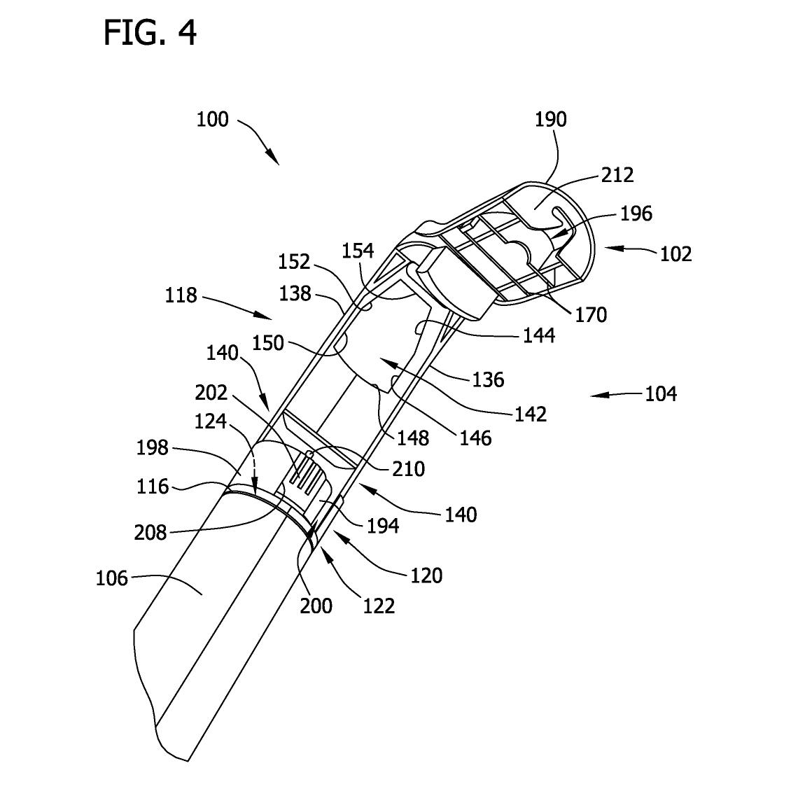

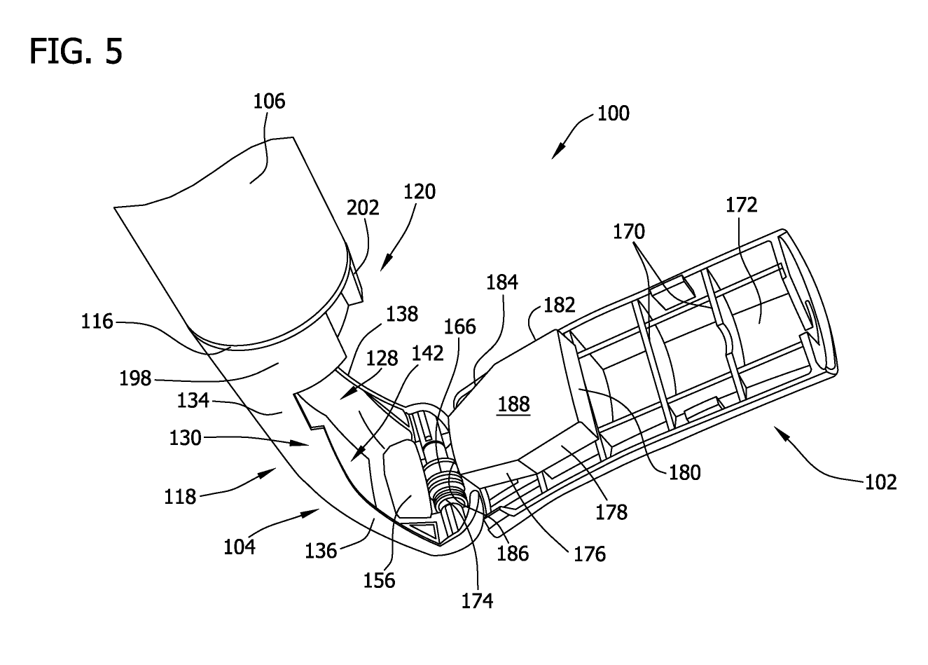

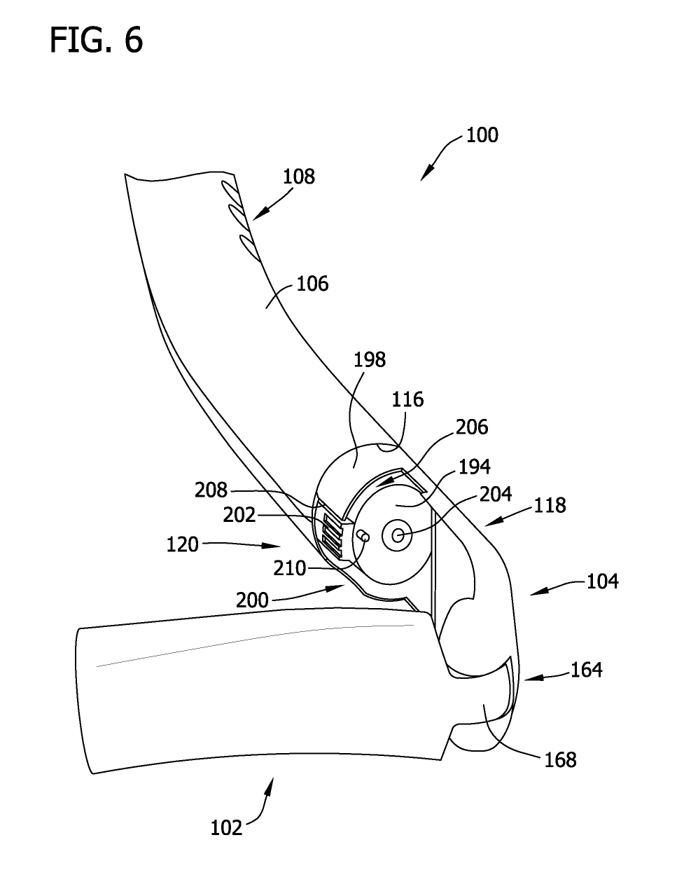

FIG. 1 is a top view of an exemplary sample collection apparatus 100 with a cover 102 in an open position. FIG. 2 is a side view of sample collection apparatus 100. FIG. 3 is a bottom view of sample collection apparatus 100. FIG. 4 is a top perspective view of a sample collection assembly 104 of sample collection apparatus 100. FIG. 5 is a side perspective view of sample collection assembly 104. FIG. 6 is an end perspective view of sample collection assembly 104.

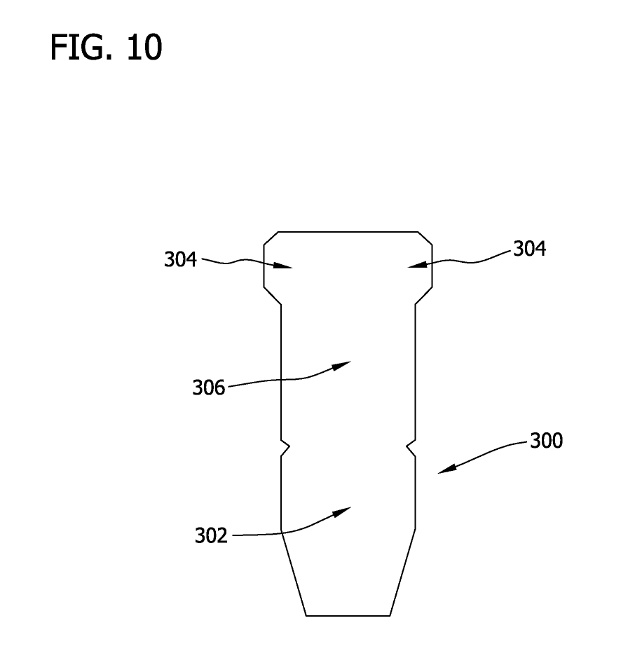

Referring to FIGS. 1-3, sample collection apparatus 100 is configured to be used with a collection trap, such as a collection trap 300 (shown in FIG. 10). Apparatus includes a handle 106 and sample collection assembly 104 coupled to handle 106. Handle 106 is generally cylindrical and has a length that is longer than a length of sample collection assembly 106. In the exemplary embodiment, handle 106 has any suitable length that enables a user to contact sample collection assembly 104 against a person and/or an object that may have trace particles associated therewith. In a particular embodiment, sample collection apparatus 100 includes an extension section (not shown) coupled between sample collection assembly 104 and handle 106 to adjust the length of apparatus 100. In the exemplary embodiment, handle 106 includes a gripping portion 108 proximate a first end 110 thereof. Gripping portion 108 may include indentations 112. Further, in the exemplary embodiment, handle 106 includes a notch 114 defined therein adjacent a second end 116 of handle 106. Notch 114 is configured to facilitate aligning sample collection assembly 104 with handle 106. As used herein, the term “adjacent” refers to at least two components and/or surfaces that are in direct contact with each other and/or positioned side-by-side in spaced relation to each other.

Referring to FIGS. 1-6, sample collection assembly 104 includes cover 102, a cradle 118, and a locking mechanism 120. Cradle 118 is coupled to handle 106 at a first end portion 122 of cradle 118. More specifically, a coupling extension (not shown) extends from a first end wall 124 at first end portion 122 and is configured to be received within a hollow cavity (not shown) of handle 106 to couple sample collection assembly 104 to handle 106. First end wall 124 is configured to be positioned adjacent first end 110 of handle 106 when sample collection assembly 104 is coupled to handle 106. In the exemplary embodiment, a projection 126 extends upward from the coupling extension and outward from first end wall 124. Projection 126 is configured to be received within notch 114 to facilitate aligning sample collection assembly 104 with handle 106.

Cradle 118 includes an inner surface 128, and outer surface 130, and an upper edge 132 extending between inner surface 128 and outer surface 130. Inner surface 128 is also referred to herein as an upper surface, and outer surface 130 is also referred to herein as a lower surface. Inner surface 128 and outer surface 130 are arcuately shaped to define a bottom wall 134 and side walls 136 and 138 extending upward from bottom wall 134. Cradle 118 includes slots 140 defined along upper edge 132 adjacent locking mechanism 120. Slots 140 are configured to partially surround a grasping portion 304 (shown in FIG. 10) of collection trap 300 positioned on cradle 118, as described in more detail below. Further, cradle 118 is configured to receive collection trap 300 adjacent inner surface 128 thereof such that collection trap 300 substantially extends over an opening 142.

Referring to FIGS. 4 and 5, in the exemplary embodiment, opening 142 is defined through cradle 118 by vertical side walls 144, 146, 148, 150, 152, and 154 extending between inner surface 128 and outer surface 130 of cradle 118. Vertical side walls 144 and 146 are defined adjacent cradle side wall 136 and vertical side walls 150 and 152 are defined adjacent cradle side wall 138 such that bottom wall 134 does not extend between vertical side walls 144, 146, 150, and 152 and a respective side walls 136 or 138. Vertical side walls 148 and 154 extend transversely across bottom wall 134. Although opening 142 is defined by six vertical side walls in the exemplary embodiment, opening 142 can be defined by more or less than six vertical side walls. In the exemplary embodiment, a second end wall 156 of cradle 118 is defined adjacent vertical wall 154. Second end wall 156 is configured to act as a stop for cover 102, as described in more detail below.

Referring again to FIGS. 1-6, cover 102 includes a projection member 158 and a block 160 extending from projection member 158. Cover 102 is hingedly coupled to a second end portion 162 of cradle 118. More specifically, projection member 158 includes a coupling portion 164 including a hinged portion 166 and a stop 168. Hinged portion 166 is configured to receive an elongated member (not shown) therethrough to couple projection member 158 to cradle 118 at cradle second end portion 162. Stop 168 extends about hinged portion 166 and at least partially covers hinged portion 166. Stop 168 is further configured to contact cradle second end wall 156 to prevent rotation of cover 102, as described in more detail below. In the exemplary embodiment, projection member 158 includes a plurality ribs 170 extending from an inner surface 172 of member 158 to provide strength to member 158. Ribs 170, stop 168, and hinged portion 166 are formed integrally as one piece with member 158 in the exemplary embodiment.

A biasing mechanism, such as a spring 174, is positioned between cradle 118 and cover 102 to bias cover 102 to the open position in which cover 102 is away from cradle 118. More specifically, spring 174 is positioned about hinged portion 166 to bias cover 102 to the open position. When cover 102 is biased to the open position stop 168 contacts second end wall 156 to prevent further rotation of cover 102 with respect to cradle 118.

Block 160 is coupled to projection member 158 on, for example, ribs 170, and extends downwardly from projection member 158. In the exemplary embodiment, fasteners (not shown) are coupled to inner surface 172 of cradle 118 and extend downwardly. Block 160 includes apertures (not shown) configured to receive at least a portion of a respective fastener to secure block 160 to projection member 158. As such, block 160 can be removed from projection member 158 by removing block 160 from the fasteners. In the exemplary embodiment, block 160 includes an elastomer pliant material including, but not limited to, silicone, BUNA-N, and/or other hybrid polymer(s).

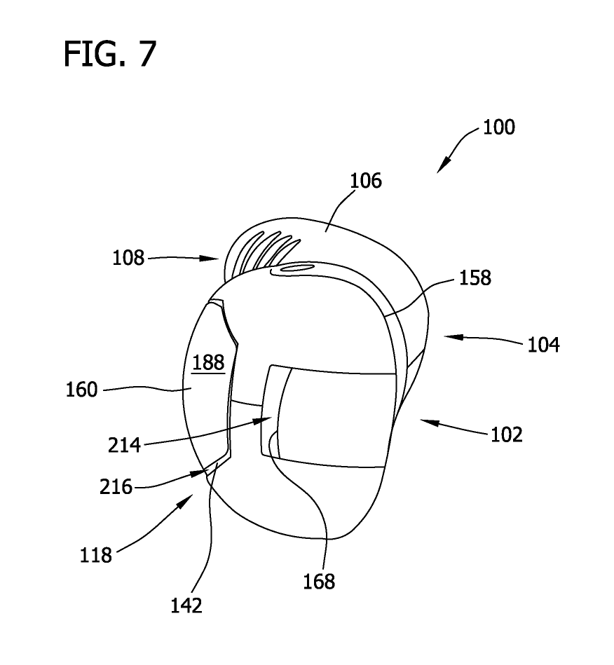

Block 160 is configured to be at least partially inserted through cradle opening 142. More specifically, as shown in FIG. 5, block 160 includes side walls 176, 178, 180, 182, 184, and 186 that define a shape of block 160. In the exemplary embodiment, block 160 has a shape that corresponds to a shape of cradle opening 142 defined by vertical side walls 144, 146, 148, 150, 152, and 154. Further, in the exemplary embodiment, block 160 has a height that enables a lower wall 188 of block 160 to be generally flush with cradle outer surface 130 and/or extend beyond cradle outer surface 130 when cover 102 is in the closed position, as shown in FIG. 7. As such, block 160 is configured to force collection trap 300 at least partially through cradle opening 142 such that collection trap 300 is secured between vertical side walls 144, 146, 148, 150, 152, and 154 of opening 142 and side walls 176, 178, 180, 182, 184, and 186 of block 160. Lower wall 188 is configured to contact collection trap 300 when cover 102 is in the closed position.

Locking mechanism 120 is coupled to cradle 118 adjacent first end portion 122 thereof More specifically, locking mechanism 120 is positioned adjacent first end wall 124 and at least partially moveable with respect to first end wall 124. Locking mechanism 120 is configured to releasably couple to a free end 190 of cover 102 opposite a hinged end 192 of retention member 158. Block 160 at least partially extends through cradle opening 142 when locking mechanism 120 is coupled to cover 102.

Referring to FIGS. 4-6, in the exemplary embodiment, locking mechanism 120 includes a slider 194 and an engagement slot 196. More specifically, a flange 198 extends annularly about first end wall 124, and slider 194 is positioned at least partially within flange 198 such that flange 198 extends circumferentially about slider 194. Flange 198 includes a gap 200, and slider 194 includes an activation projection 202 that extends into and/or through gap 200 and is moveable within gap 200. Activation projection 202 is configured to allow a user to rotate slider 194 with respect to flange 198, as described in more detail below. A fastener 204 extends through slider 194 and first end wall 124 into the coupling extension. Slider 194 rotates about fastener 204 within flange 198. A space 206 is defined between slider 194 and flange 198. Locking mechanism 120 further includes a biasing mechanism (not shown) that biases slider 194 in a clockwise direction as viewed in FIG. 6. A first side 208 of flange gap 200 contacts activation projection 202 to prevent slider 194 from rotating. A peg 210 projects from slider 194 adjacent activation projection 202.

Engagement slot 196 is defined in an end wall 212 of projection member 158. Engagement slot 196 is configured to push peg 210 in a counter-clockwise direction and to allow peg 210 to bias in the clockwise direction to secure cover 102 in the closed position. Alternatively, sample collection assembly 104 includes any suitable locking mechanism that releaseably secures cover 102 in the closed position.

In an alternative embodiment, sample collection assembly 104 further include a peg (not shown) extending upwardly from inner surface 128 of cradle 118, and collection trap 300 includes an aperture (not shown) defined therethrough. The peg is configured to be inserted through the aperture to secure collection trap 300 in position within cradle 118. In such an embodiment, the peg can be removable from cradle 118.

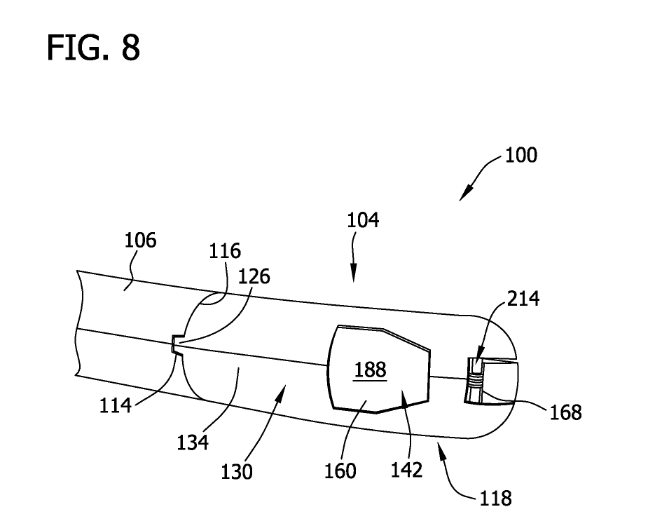

FIG. 7 is an end view of sample collection apparatus 100 with cover 102 in the closed position. FIG. 8 is a bottom view of sample collection apparatus 100. In FIGS. 7 and 8, cover 102 covers cradle 118 and is secured in the closed position using locking mechanism 120 (shown in FIGS. 1-6). More specifically, peg 210 (shown in FIGS. 4 and 6) of slider 194 (shown in FIGS. 4-6) is inserted into engagement slot 196 (shown in FIG. 4) and is biased in the clockwise direction to prevent disengagement from slot 196. Further, because cover 102 is biased to the open position, additional force is applied to peg 210 and/or slot 196 to prevent disengagement. In the closed position, stop 168 is not contacting end wall 156 (shown in FIG. 5) and a gap 214 is defined between stop 168 and cradle 118. Further, block 160 extends at least partially through opening 142 such that lower wall 188 of block 160 is generally flush with cradle outer surface 130 and/or extends beyond cradle outer surface 130. A space 216 is defined between block side walls 176, 178, 180, 182, 184, and 186 and opening vertical side walls 144, 146, 148, 150, 152, and 154.

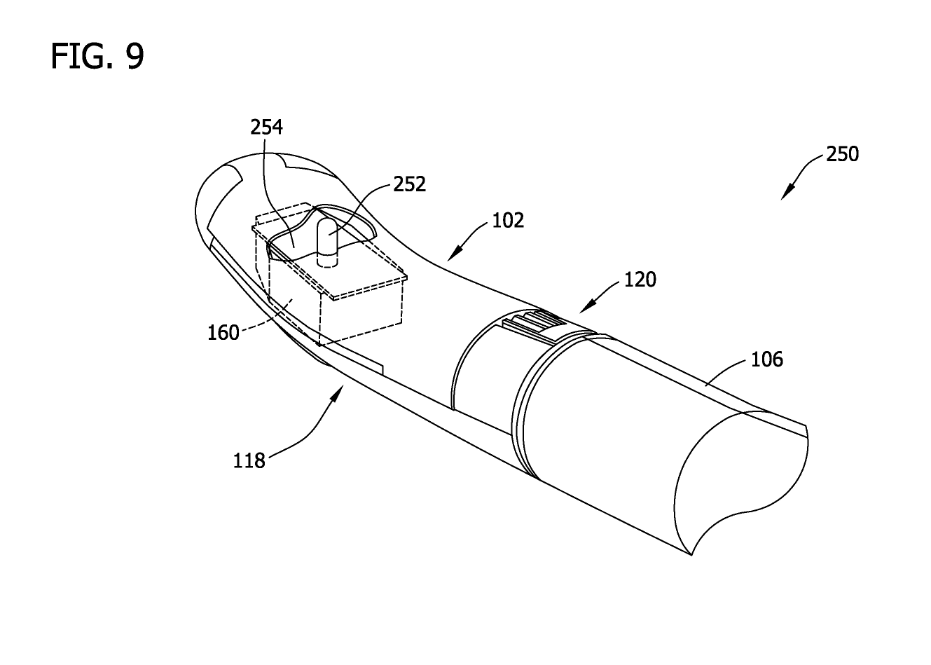

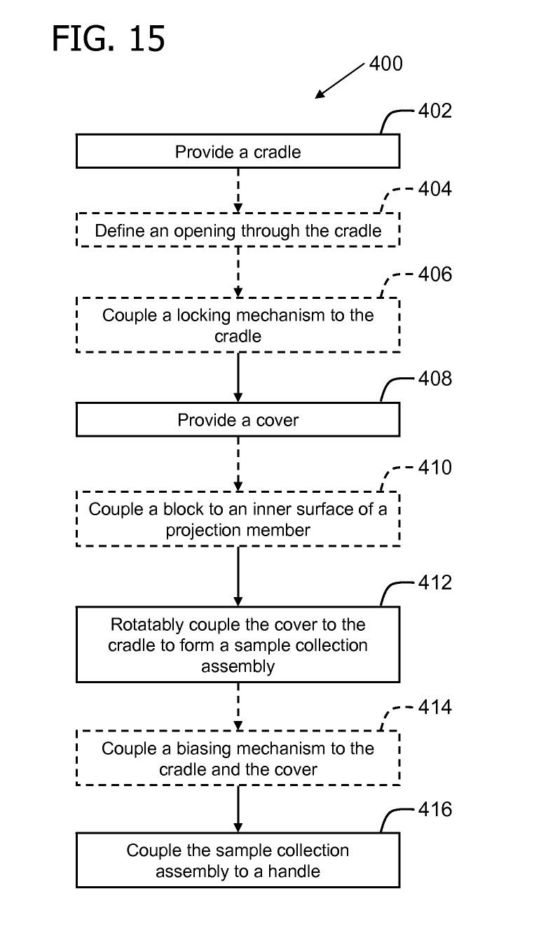

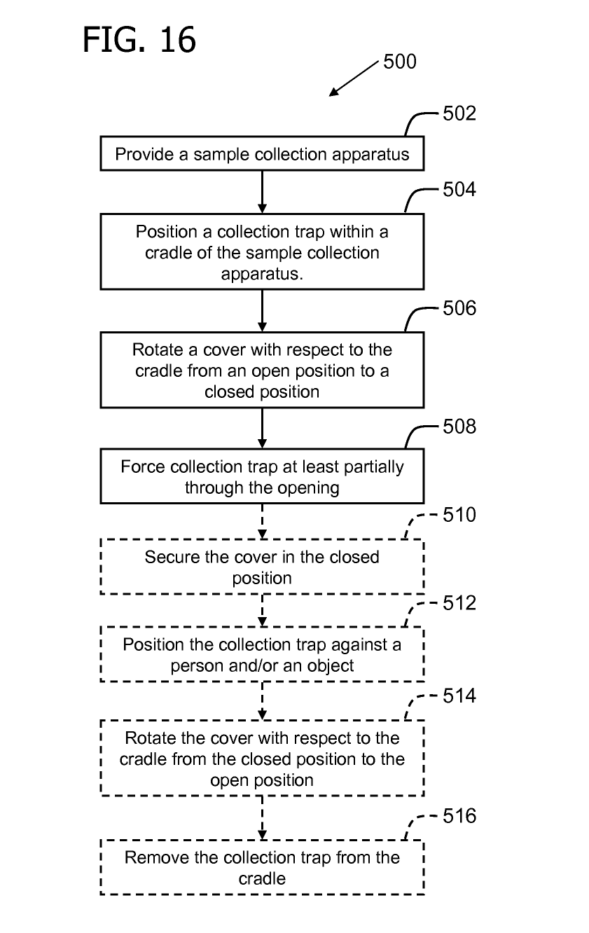

FIG. 9 is a top perspective view of an exemplary alternative sample collection apparatus 250. Sample collection apparatus 250 is substantially similar to sample collection apparatus 100 (shown in FIGS. 1-8), except sample collection apparatus 250 includes an indicator 252. As such, components shown in FIG. 9 are labeled with the same reference numbers used in FIGS. 1-8. Sample collection apparatus 250 can be used with a trap, such as trap 300 (shown in FIG. 10), similarly to sample collection apparatus 100 (shown in FIGS. 10-14). Further, sample collection apparatus 250 can be used with the methods described with respect to FIGS. 15 and 16.

More specifically, a sensor 254, such as a pressure sensor, is positioned adjacent block 160 within cover 102, and indicator 252 is in communication with sensor 254. Sensor 254 is configured to determine whether sample collection apparatus 250 is in contact with a person and/or an object to sufficiently collect a sample. For example, sensor 254 measures a pressure and/or orientation of sample collection apparatus 250 against the person and/or the object.

When sample collection apparatus 250 is in sufficient contact with the person and/or the object, indicator 252 outputs a visual and/or auditory signal to the user. In the exemplary embodiment, indicator 252 includes a light-emitting diode (LED) that is activated when sample collection apparatus 250 is in sufficient contact to collect a sample. As such, when there is sufficient contact, indicator 252 is continuously lighted. In a particular embodiment, indicator 252 can flash off and on when there is insufficient contact and can be continuously lighted when there is sufficient contact. Alternatively, indicator 252 can flash off and on when there is sufficient contact. In the exemplary embodiment, sensor 254 and indicator 252 act as a feedback indicator that helps ensure the user is taking repeatable samples on trap 300.

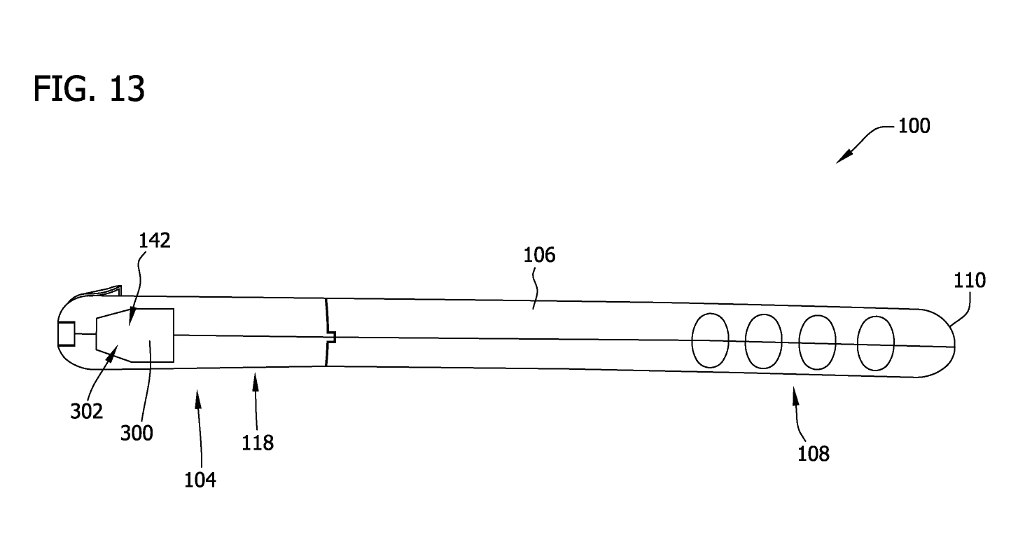

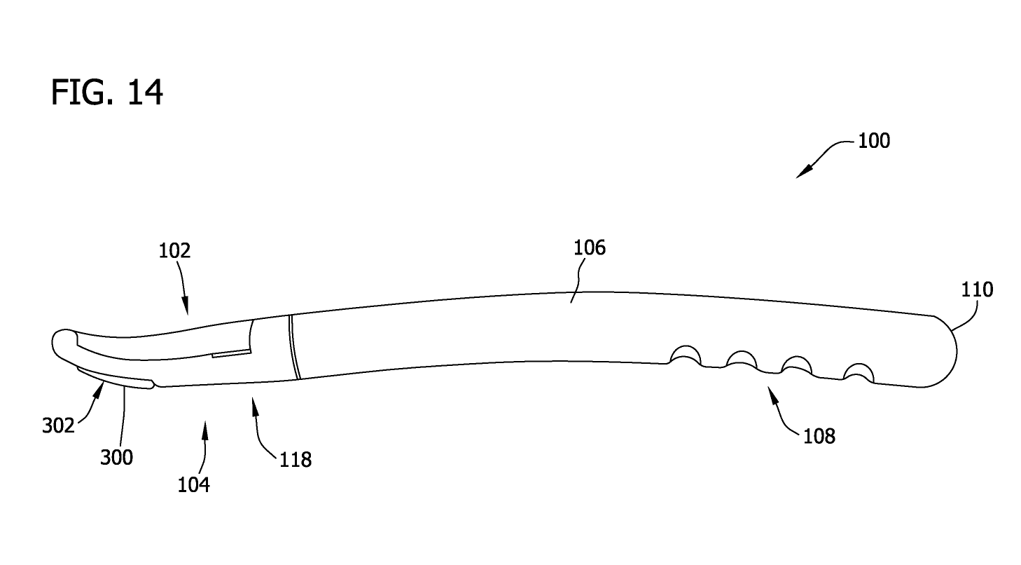

FIG. 10 is a top view of an exemplary collection trap 300 that may be used with sample collection apparatus 100 (shown in FIGS. 1-8) and/or sample collection apparatus 250 (shown in FIG. 9). Collection trap 300 is formed from a sheet of material configured to trap trace particles thereon and/or therein. In a particular embodiment, collection trap 300 is formed from a material described in U.S. Pat. No. 6,815,670, which is hereby incorporated by reference in its entirety. In the exemplary embodiment, collection trap 300 includes a collection portion 302 and grasping portions 304. An intermediate portion 306 extends between collection portion 302 and grasping portions 304. Collection portion 302 is configured to come into contact with block 160 (shown in FIGS. 1-8) to be forced at least partially through cradle opening 142 (shown in FIGS. 1-8). As such, collection portion 302 is accessible when cover 102 (shown in FIGS. 1-8) is in the closed position, as shown in FIGS. 13 and 14.

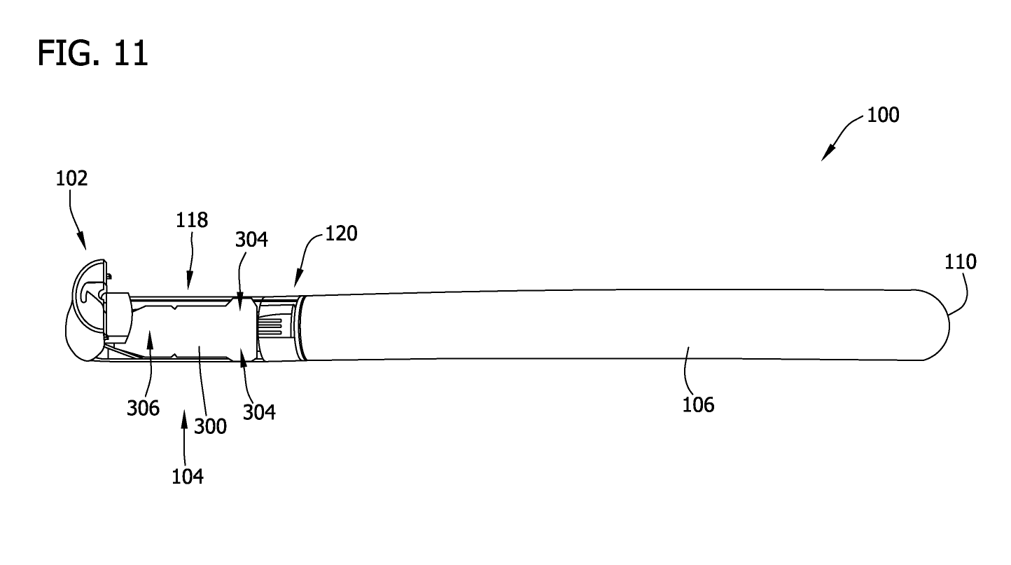

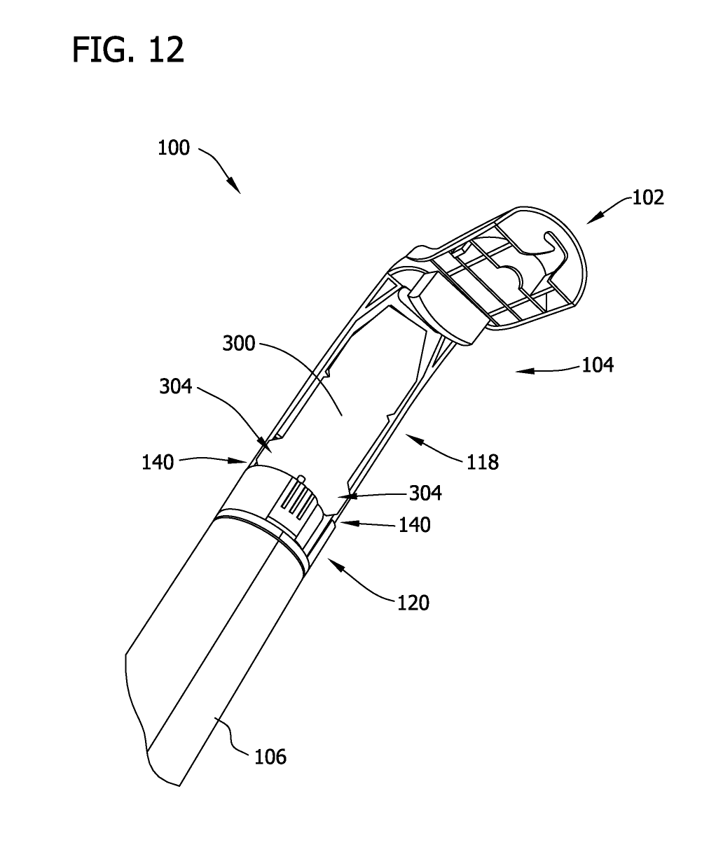

FIG. 11 is a top view of sample collection apparatus 100 (shown in FIGS. 1-8) including collection trap 300 (shown in FIG. 10) with cover 102 in the open position. FIG. 12 is a top perspective view of sample collection apparatus 100 and collection trap 300. When cover 102 is in the open position, collection trap 300 can be positioned within cradle 118. More specifically, collection trap 300 is positioned within cradle 118 above cradle inner surface 128 (shown in FIG. 1) to cover opening 142. In such a position, grasping portions 304 of collection trap 300 extend through slots 140.

FIG. 13 is a top view of sample collection apparatus 100 (shown in FIGS. 1-8) including collection trap 300 (shown in FIG. 10) with cover 102 in the closed position. FIG. 14 is a top perspective view of sample collection apparatus 100 and collection trap 300. As shown in FIGS. 13 and 14, block 160 forces collection trap 300 at least partially through opening 142. More specifically, when cover 102 is in the closed position, collection trap 300 is secured between vertical side walls 144, 146, 148, 150, 152, and 154 (shown in FIG. 4) of opening 142 and side walls 176, 178, 180, 182, 184, and 186 (shown in FIG. 5) of block 160 (shown in FIGS. 1-8). Lower wall 188 (shown in FIG. 5) of block 160 contacts collection trap 300 to force collection trap 300 at least partially through opening 142. As such, collection portion 302 of trap 300 is accessible through opening 142 to contact a person and/or object to collect a sample of a substance, such as a sample of trace particles.

FIG. 15 is a flowchart of an exemplary method 400 of making and/or assembling sample collection apparatus 100 (shown in FIGS. 1-8) and/or sample collection apparatus 250 (shown in FIG. 9). Sample collection apparatus 100 is referred to for clarity, unless otherwise notes. As used herein, the terms “provide,” “providing,” and variations thereof refer to supplying, furnishing, preparing, presenting, procuring, purchasing, transferring, producing, manufacturing, fabricating, forging, machining, molding, constructing, and/or any other suitable means to provide a component.

Referring to FIGS. 1-9 and 15, method 400 includes providing 402 cradle 118 including inner surface 128 and opposing outer surface 130. Cradle 118 can be provided 402 with opening 142 defined therethrough, or opening 142 can be defined 404 through cradle 118 after cradle 118 is provided 402. Further, locking mechanism 120 is coupled 406 to cradle 118 to form a portion of sample collection assembly 104. Locking mechanism 120 is configured to couple to cover 102 to releasably secure cover 102 in the closed position.

Cover 102 is provided 408, wherein cover 102 includes projection member 158 and block 160 configured to be at least partially inserted through cradle opening 142. Cover 102 can be provided 408 with block 160 coupled to projection member 158, or block 160 can be coupled 410 to projection member 158 after projection member 158 is provided 408. More specifically, block 160 is removably coupled 410 adjacent inner surface 172 of projection member 158 using the apertures and fasteners described above. In the exemplary embodiment, cover 102 is rotatably coupled 412 to second end portion 162 of cradle 118 to form sample collection assembly 104. More specifically, hinged portion 166 of cover 102 is coupled to cradle 118 adjacent cradle end wall 156 such that cover 102 rotates with respect to cradle 118. The biasing mechanism, such as spring 174, is coupled 414 to cradle 118 and cover 102 to bias cover 102 to the open position.

Method 400 further includes coupling 416 sample collection assembly 104 to end 116 of handle 106. More specifically, first end portion 122 of cradle 118 is coupled 416 to handle 106. In the exemplary embodiment, sample collection assembly 104 is coupled 416 to handle 106 by inserting the coupling extension into a hollow end of handle 106. The coupling extension is friction fit against an inner surface of handle 106 such that sample collection assembly 104 can be removed from handle 106. Alternatively, sample collection assembly 104 is coupled 416 to handle 106 using any suitable permanent or temporary coupling method and/or mechanism. In an alternative embodiment, sample collection assembly 104 is coupled 416 to handle 106 via an extension section. More specifically, the coupling portion of sample collection assembly 104 is friction fit into the extension section, and a coupling portion (not shown) of the extension section is friction fit into handle 106.

FIG. 16 is a flowchart of an exemplary method 500 of using sample collection apparatus 100 (shown in FIGS. 1-8 and 10-14) and/or sample collection apparatus 250 (shown in FIG. 9). Method 500 can be used to collect a sample of a substance using sample collection apparatus 100 and/or sample collection apparatus 250. Sample collection apparatus 100 is referred to for clarity, unless otherwise notes.

Referring to FIGS. 1-14 and 16, method 500 includes providing 502 sample collection apparatus 100 including sample collection assembly 104 coupled to handle 106. Sample collection assembly 104 includes cradle 118 and cover 102, wherein cover 102 is in the open position with respect to cradle 118. Collection trap 300 is positioned 504 within cradle 118 such that collection trap 300 covers opening 142 defined through cradle 118. More specifically, collection trap 300 is positioned 504 adjacent inner surface 128 of cradle 118 to cover opening 142. Cover 102 is rotated 506 with respect to cradle 118 from the open position to the closed position. Collection trap 300 is forced 508 at least partially through opening 142 using block 160 extending from cover 102.

Further, cover 102 is secured 510 in the closed position using locking mechanism 120. More specifically, as cover 102 is rotated 506 toward cradle 118, engagement slot 196 contacts peg 210 to rotate slider 194 in the counter-clockwise direction. As cover 102 continues to rotate, engagement slot 196 allows slider 194 to rotate in the clockwise direction due to the biasing force on slider 194. After slider 194 rotates in the clockwise direction, cover 102 is secured 510 in the closed position by peg 210 in engagement slot 196.

Collection trap 300 is then positioned 512 against a person and/or an object to collect the sample of the substance from the person and/or the object. For example, a user grasping handle 106 can manipulate sample collection apparatus 100 to touch collection trap 300 against and/or pull collection trap 300 across the person and/or object to collect the sample, such as a sample of trace particles. When sample collection apparatus 250 (shown in FIG. 9) is used, indicator 252 (shown in FIG. 9) outputs a visual and/or auditory signal to the user when sample collection apparatus 250 is in sufficient contact with the person and/or the object.

To remove collection trap 300 from sample collection apparatus 100, cover 102 is rotated 514 with respect to cradle 118 from the closed position to the open position after, for example, the sample of the substance has been collected on collection trap 300. More specifically, the user touches activation projection 202 of locking mechanism 120 and rotates slider 194 in the counter-clockwise direction to disengage peg 210 from slot 196. Spring 174 rotates 514 cover 106 to the open position upon disengaging peg 210 from slot 196. Stop 168 contacts end wall 156 to prevent further rotation of cover 102 with respect to cradle 118. The user can then remove 516 collection trap 300 from cradle 118 to test the sample collected on collection trap 300. More specifically, the user can hold collection trap 300 at at least one grasping portion 304 to remove 516 collection trap 300 from sample collection apparatus 100. As such, the user does not contact collection portion 302 of collection trap 300. Collection trap 300 can then be reused until a collected sample tests positive for contraband and/or until collection trap 300 has been used a predetermined number of times. Collection trap 300 can then be disposed of. Alternatively, collection trap 300 can be disposed of after one use.

Exemplary embodiments of a sample collection apparatus and methods for making and using the same are described above in detail. The methods and apparatus are not limited to the specific embodiments described herein, but rather, components of systems and/or steps of the methods may be utilized independently and separately from other components and/or steps described herein. For example, the methods may also be used in combination with other sample collections systems and methods, and are not limited to practice with only the trace particle systems and methods as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A sample collection apparatus for use with a collection trap, the apparatus comprising:
a handle; and
a sample collection assembly coupled to the handle, the sample collection assembly comprising:
a cradle coupled to the handle at a first end portion of the cradle, the cradle comprising an opening defined therethrough by vertical side walls extending between an upper surface of the cradle and a lower surface of the cradle; and
a cover comprising a projection member and a block, the cover coupled to a second end portion of the cradle, the projection member comprising the block configured to be at least partially inserted through the cradle opening.

2. A sample collection apparatus in accordance with claim 1, further comprising a locking mechanism coupled the cradle adjacent the first end portion thereof, the locking mechanism configured to releasably couple to a free end of the cover, the block at least partially extending through the cradle opening when the locking mechanism is coupled to the cover.

3. A sample collection apparatus in accordance with claim 2, wherein the cradle comprises slots along an upper edge thereof adjacent the locking mechanism, at least a portion of the collection trap extending through the slots when the collection trap is positioned on the cradle.

4. A sample collection apparatus in accordance with claim 1, wherein the block has a shape that corresponds to a shape of the cradle opening defined by the vertical side walls.

5. A sample collection apparatus in accordance with claim 1, wherein the block comprises a pliant material.

6. A sample collection apparatus in accordance with claim 1, wherein the cradle is configured to receive the collection trap adjacent the upper surface thereof such that the collection trap substantially extends over the opening.

7. A sample collection apparatus in accordance with claim 6, wherein the block is configured to force the collection trap at least partially through the opening.

8. A sample collection apparatus in accordance with claim 1, wherein side walls of the cradle are adjacent the vertical side walls of the opening.

9. A sample collection apparatus in accordance with claim 1, further comprising a spring positioned between the cradle and the cover to bias the cover to an open position.

10. A sample collection apparatus in accordance with claim 1, further comprising an extension section coupled between said sample collection assembly and said handle.

11. A method for using a sample collection apparatus to collect a sample of a substance, the method comprising:
providing the sample collection apparatus including a sample collection assembly coupled to a handle, the sample collection assembly including a cradle and a cover, the cover in an open position with respect to the cradle;
positioning a collection trap within the cradle such that the collection trap covers an opening defined through the cradle;
rotating the cover with respect to the cradle from the open position to a closed position; and
forcing the collection trap at least partially through the opening using a block extending from the cover.

12. A method in accordance with claim 11, wherein the sample collection assembly further includes a locking mechanism, the method further comprising:
securing the cover in the closed position using the locking mechanism.

13. A method in accordance with claim 11, further comprising positioning the collection trap against at least one of a person and an object to collect the sample of the substance.

14. A method in accordance with claim 11, further comprising rotating the cover with respect to the cradle from the closed position to the open position after the sample of the substance has been collected on the collection trap.

15. A method in accordance with claim 14, further comprising removing the collection trap from the cradle to test the sample collected on the collection trap.

16. A method for making a sample collection apparatus, the method comprising:
providing a cradle including an inner surface and an opposing outer surface, the cradle including an opening defined therethrough by vertical side walls extending between the inner surface of the cradle and the outer surface of the cradle;
providing a cover including a projection member and a block configured to be at least partially inserted through the cradle opening;
rotatably coupling the cover to a first end portion of the cradle, the cover and the cradle forming a sample collection assembly; and
coupling the sample collection assembly to an end of a handle.

17. A method in accordance with claim 16, wherein coupling the sample collection assembly to an end of a handle comprises coupling a second end portion of the cradle to the handle.

18. A method in accordance with claim 16, wherein providing a cover further comprises coupling the block to an inner surface of the projection member.

19. A method in accordance with claim 16, wherein providing a cover further comprises providing a cover having a block with a shape corresponding to a shape of the cradle opening.

20. A method in accordance with claim 16, further comprising coupling a locking mechanism to the cradle to form the sample collection assembly, the locking mechanism configured to couple to the cover to releasably secure the cover in a closed position.

21. A method in accordance with claim 16, further comprising coupling a biasing mechanism to the cradle and the cover to bias the cover to an open position.
